(19) United States
(12) Patent Application Publication
(10) Pub. No.: US 2015/0294261 A1
(43) Pub. Date: Oct. 15, 2015

(54) PACKAGE DELIVERY SYSTEMS AND METHODS

(71) Applicant: myDoorman Inc., San Francisco, CA (US)

(72) Inventor: Alexander Adell, San Francisco, CA (US)

(21) Appl. No.: 14/597,558

(22) Filed: Jan. 15, 2015

Related U.S. Application Data
(60) Provisional application No. 61/934,156, filed on Jan. 31, 2014.

(51) Int. Cl. G06Q 10/08

(52) U.S. Cl. CPC G06Q 10/083

(57) ABSTRACT

Methods and support systems for synchronizing delivery time and place of a deliverable item to consumers, the method including, upon receipt of the deliverable item at a pre-designated shipping address, establishing communication via a communication network with a communication device of a discrete consumer who purchased the deliverable item from an online merchant; and arranging a delivery date and time for transporting the deliverable item from the pre-designated shipping address to a desired final shipping address over the communication device of the discrete consumer.

### CROSS-REFERENCE TO RELATED APPLICATIONS

This application is a non-provisional utility patent application claiming priority to and the benefit of provisional U.S. Patent Application No. 61/934,156, filed Jan. 31, 2014, the entire contents of which are incorporated by reference herein.

### BACKGROUND OF THE INVENTION

Retail sales on the Internet were revolutionized in the 1990s with the introduction of secure online shopping. As a result, consumers could conveniently purchase items whenever and wherever they had access to the Internet. Initially, electronic merchants dealt with many challenges, including developing a reliable shipping method to deliver products to the consumer. In one example, online merchants ultimately settled on providing Web forms in which consumers input a shipping address and, in some instances, a preferred delivery means, e.g., U.S. Postal Service, express mail, United Parcel Service (UPS), Federal Express (FedEx), and the like.

As a result of many factors, retail package delivery of items purchased online transformed into a “push” system, in which delivery times are determined by the carrier rather than being established for the consumer's convenience. Accordingly and disadvantageously, these “push” systems optimize asynchronous delivery, which usually occurs during daylight hours and, typically, within a four-hour delivery window. As a result, an attempt to complete package delivery to any shipping address is made whether or not the consumer is available to be at that address on the day and at the time of delivery.

Asynchronous delivery has many disadvantages and costs. While in some delivery areas, a package may be left at the consumer's door or, alternatively, may be left with a neighbor, in other areas delivery protocol forbids leaving a package when the consumer or a member of the consumer's family is not at home to receive it and sign for it. This is especially true when the item being shipped is a high-value item and/or when the delivery area is in a high-population or high-crime area.

Failure to deliver a package on a first attempt may result in one or more attempts by the carrier to find a time when the consumer is at home. For example, after failing to make a delivery on a first or subsequent attempt, the carrier may leave a note providing the next date and time window that the carrier will try to make the delivery. Here again, the “push” systems operate at the convenience of the carrier and not the consumer. Eventually, after repeated failures to make a delivery, the carrier may instead leave a note requiring the consumer to either pick the package up herself at a designated location or may provide a number for the consumer to call, to set up a delivery date and time window at the consumer's convenience. Adding further complications, online merchants may use a variety of carriers (unless expressly requested by the consumer at the time of purchase) and, moreover, delivery protocols among the various carriers may differ.

The inefficiencies of such a system on time and resources beg for relief. Accordingly, it would be advantageous to provide a system and method for universal package delivery via any shipping carrier of items purchased from any online merchant. More specifically, it would be advantageous to provide a system and method to provide consumers with improved package receiving, delivery scheduling, and package delivery than are possible using the asynchronous “push” system in current use.

### SUMMARY OF THE INVENTION

Various aspects of the invention provide techniques and supporting systems that enable universal package delivery via any shipping carrier of items purchased from any online merchant or that require delivery. For example, in a first aspect, a method for synchronizing delivery time and place of a deliverable item to at least one consumer is disclosed. In some embodiments, the method includes, upon receipt of the deliverable item at a pre-designated, interim shipping address, establishing communication via a communication network with a communication device of a discrete consumer who purchased the deliverable item from an online merchant and arranging a delivery date and time for transporting the deliverable item from the pre-designated shipping address to a desired final shipping address over the communication device of the discrete consumer.

In certain implementations, the method may include one or more of the following steps: preregistering a consumer(s) for universal delivery of the deliverable item, verifying that the consumer(s) has pre-registered for universal delivery of the deliverable item, receiving at the pre-designated shipping address the deliverable item from a first carrier, and coordinating delivery of the deliverable item with a second carrier.

In some variations, the method may further include identifying the discrete consumer, verifying that the discrete consumer has registered for delivery of online purchases to the pre-designated sipping address, and/or dynamically replacing a shipping address associated with the discrete consumer with the pre-designated shipping address. The method may also include verifying that the pre-designated shipping address geographically covers the shipping address of the discrete consumer and providing alerts to the discrete consumer. The alerts may, for example, notify the discrete consumer once the second carrier has picked up the deliverable item at the pre-designated shipping address, notify the discrete consumer once the second carrier is within a pre-determined distance to the desired final shipping address, notify the discrete consumer once the second carrier is within a pre-determined time to the desired final shipping address, and/or notify the discrete consumer if the second carrier is delayed.

In further implementations, the method may also include, upon receipt of a return request, establishing communication with the consumer and arranging a pick-up date and time for transporting the deliverable item from the final shipping address to the pre-designated shipping address. In some cases, the process includes receiving the returned item via a third carrier at the pre-designated shipping address and, in some cases, coordinating return of the returned item to the online merchant via a fourth carrier.

In a second aspect, embodiments of the invention provide a package delivery system for synchronizing the delivery time and location of physical goods. The system includes a non-transitory, machine-readable medium for storing information and a data processor(s) adapted to execute instructions stored in the non-transitory, machine-readable medium. In some implementations, the data processor(s) is configured to, upon receipt of the an item(s) at a pre-designated shipping address, establish communication via a communication network with a communication device of a discrete consumer who has purchased the item(s) from an online merchant and arrange a delivery date and time for transporting the item(s) from the pre-designated shipping address to a desired final shipping address.

In some implementations, the data processor(s) is further configured to provide the consumer with geographical positioning information when transporting the item from the pre-designated shipping address to a desired final shipping address. In some variations, the data processor(s) is further configured to verify that the consumer(s) has pre-registered for universal delivery of the deliverable item, identify the discrete consumer, verify that the discrete consumer has registered for delivery of online purchases to the pre-designated sipping address, and dynamically replace a shipping address associated with the discrete consumer with the pre-designated shipping address. In some implementations, the data processor(s) is further configured to verify that the pre-designated shipping address geographically covers the shipping address of the discrete consumer. In some variations, the data processor(s) is further configured, upon receipt of a return request, to establish communication with the consumer who received the deliverable item and to arrange a pick-up date and time for transporting the deliverable item from the final shipping address to the pre-designated shipping address.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a block diagram of an exemplary package delivery system in accordance with some embodiments of the present invention; and

FIG. 2 shows a flow diagram of an exemplary package delivery method in accordance with some embodiments of the present invention.

### DETAILED DESCRIPTION

### Architecture and Computer System

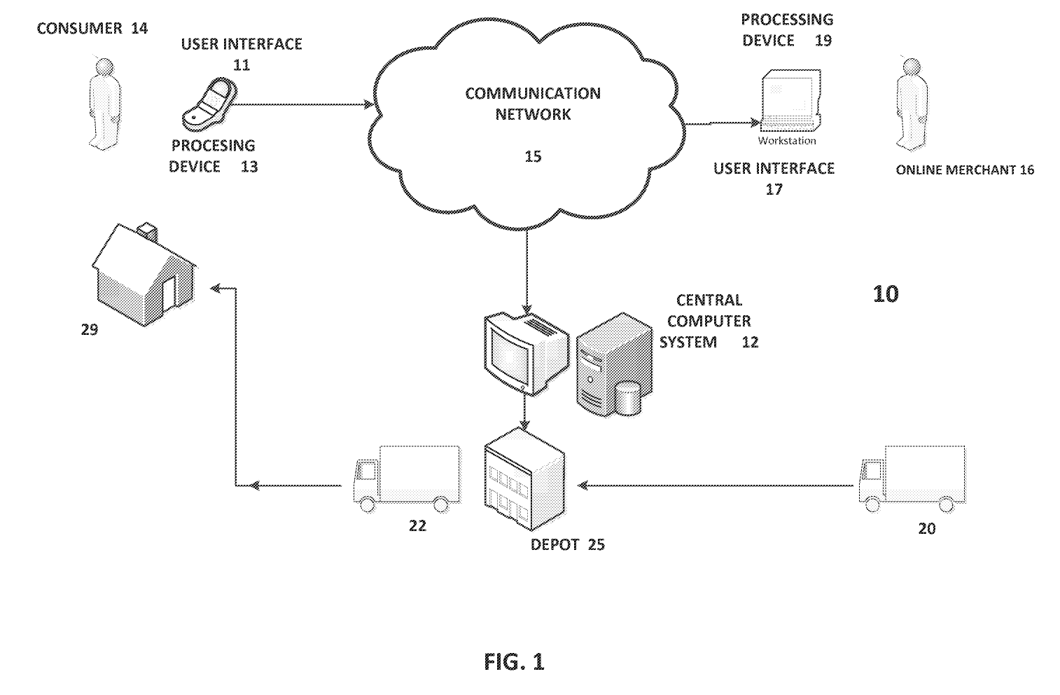

It is understood that the methods and systems described below may contain software and/or hardware connected to the Internet via a network. Computing devices used to implement the systems and methods described herein are capable of communicating with each other via the Internet or via some other communication network, and it should be appreciated that the various functionalities of the components may be implemented on any number of devices. Referring to FIG. 1, in some embodiments, the system 10 may include a central computer system 12 that is in communication with, e.g., via the communication network 15, a first plurality of user interfaces 11 and processing devices 13 of a corresponding plurality of consumers 14 and with a second plurality of user interfaces 17 and processing devices 19 of a corresponding plurality of online merchants 16. Additionally, the central computer system 12 is in communication with at least one shipping carrier 20 and 22 and a depot or warehouse 25.

A communications network 15 generally connects a client with a server, and in the case of peer-to-peer communications, connects two peers. The communication may take place via any medium such as a public-switched telephone network (PSTN), a wired or wireless local area network (LAN) or a wired or wireless wide area network (WAN) links (e.g., T1, T3, 56 kb, X.25), broadband connections (e.g., ISDN, Frame Relay, ATM), wireless personal area network (PAN), wireless links (e.g., 802.11, Bluetooth, Zigbee, IrDa or other suitable protocol), and so on. The communication network 15 may carry, for example, TCP/IP, UDP, OSI or other protocol communications, and HTTP/HTTPS requests made by a Web browser and the connection may be made between the peers and communicated over such TCP/IP networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may also be connected over the Internet, an Intranet, Extranet, Ethernet, or any other system that provides communications. Furthermore, components of the system may communicate through a combination of wired or wireless paths.

The type of network 15 is not a limitation, however, and any suitable network may be used. Non-limiting examples of networks that can serve as or be part of the communications network 15 include a wireless or wired Ethernet-based intranet, a LAN or WAN, and/or the global communications network known as the Internet, which may accommodate many different communications media and protocols.

Those skilled in the art will appreciate that the invention may be practiced with various computer system configurations, including hand-held wireless devices such as mobile phones or personal digital assistants (PDAs), multiprocessor systems, microprocessor-based or programmable consumer electronics, minicomputers, mainframe computers, and the like.

The invention may also be practiced in distributed computing environments where tasks are performed by remote processing devices that are linked through a communications network. In a distributed computing environment, program modules may be located in both local and remote computer storage media including memory storage devices.

In some cases, relational (or other structured) databases may provide such functionality, for example as a database management system which stores data related to the services and consumers utilizing the service. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, or another operating system of platform.

At a minimum, the memory includes at least one set of instructions that is either permanently or temporarily stored. The processor executes the stored instructions in order to process data. The set of instructions may include various instructions that perform a particular task or tasks. Such a set of instructions for performing a particular task may be characterized as a program, software program, software, engine, module, component, mechanism, or tool.

The system 10 may include a plurality of software processing modules stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, RUM and/or JavaScript, for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/non-removable, volatile/nonvolatile computer storage media. For example, a hard disk drive may read or write to non-removable, nonvolatile magnetic media. A magnetic disk drive may read from or writes to a removable, nonvolatile magnetic disk, and an optical disk drive may read from or write to a removable, nonvolatile optical disk such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected so as to communicate with each other in any suitable manner. Additionally, it is appreciated that each of the processor and/or memory may be composed of different physical pieces of equipment.

A user 14, 16 may enter commands and information into the processing device 13, 19 through a user interface 11, 17 that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing device 13, 19 through a user input interface 11, 17 that is coupled to a bus, but may be connected by other interface and bus structures, such as a parallel port, game port or a universal serial bus (USB).

One or more monitors or display devices may also be connected to the system bus, e.g., via a user interface 11, 17. In addition to display devices, computers may also include other peripheral output devices, which may be connected through an output peripheral interface. The computers implementing the invention may operate in a networked environment using logical connections to one or more remote computers, the remote computers typically including many or all of the elements described above.

The system user interface 11 (“UI”) may include, for example, an HTML5 application and/or a desktop Website browser that provides a standard user experience for consumers 14 who wish to buy products from online merchants 16. Using the UI 11, consumers 14 may sign up for a universal package delivery account by entering, for example, personal shipping information, personal billing information, and the like that may be used across the platform. The consumers 14 may then proceed to shop for and to buy products displayed on webpages from Websites operated by online merchants 16.

Although internal components of the computer are not shown, those of ordinary skill in the art will appreciate that such components and the interconnections are well known. Accordingly, additional details concerning the internal construction of the computer need not be disclosed in connection with the present invention.

At checkout, some online merchants 16 require first-time consumers 14 to register and provide information to complete the purchase of their products. This basic information typically includes a shipping address, credit card data, a billing address, and so forth. Some of this information is redundant. Advantageously, because the system 10 described herein captures and stores some, most, or all of the necessary data required to create consumer accounts with a generic or a specific online merchant 16—which includes a universal shipping address—the system 10 may facilitate the creation of these accounts and allow for the use of the accounts for subsequent checkouts from one or more online merchants 16.

For example, if the consumer 14 expresses interest in purchasing a product from a first online merchant 16 that requires a consumer account, a processing device in the system 10, e.g., the central computer system 12 may query the online merchant's Website to determine which consumer information fields are required to open an account. If the central computer system 12 has access to the data needed to fill in any or all of the required fields, it may automatically do so without polling the consumer 14 for additional input.

When the central computer system 12, has access to less than all of the required fields, the consumer 14 may then be polled to provide such information, which may be used to create the account with the online merchant 16. Polling may come at the request of the processing device, e.g., the central computer system 12, and/or from the online merchant's processing device 19. Any additional data provided by the consumer 14 to the processing device 19 in response to polling may also be added to the consumer's account system account information. If the consumer 14 has an existing account with the online merchant 16, the system 10 may allow the consumer 14 to enter his/her current username and password appropriate for the user's account with a specific online merchant 16. After verifying the username and password are indeed valid for the specific online merchant 16, the system 10 automatically uses these credentials for any subsequent purchases for this consumer 14 with the specific online merchant 16. Advantageously, the system 10 may also be added to the consumer's account system account information.

Having described the system architecture and computer systems, methods of using the universal package delivery to provide convenient delivery services are described below. In some instances, consumers 14 may use a Website that is sponsored and supported by the central service computer system 12 to gain information about and to register for the universal package delivery service using a processing device 13, e.g., a personal computer, a PDA, a tablet computer, a smartphone, a cell phone, and the like. Alternatively, consumers 14 may use a mobile application (“app”) that is expressly prepared for implementing and facilitating the universal package delivery service system and method described herein and, moreover, that they have downloaded onto their processing device 13, e.g., a PDA, a tablet computer, a smartphone, a cell phone, and the like. Whereas, the universal package delivery service system Website primarily enables consumers 14 to register, the mobile app enables consumers 14 to register as well as to receive notifications about shipment and delivery status and to schedule final delivery.

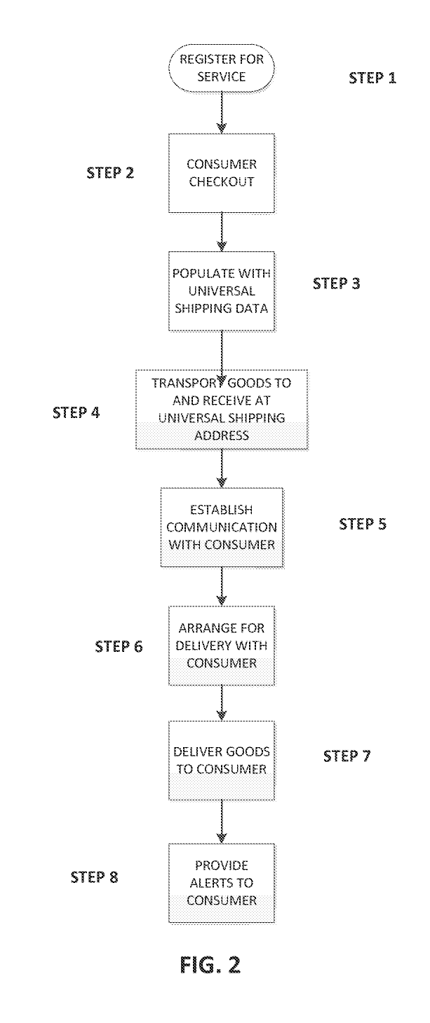

Referring to FIG. 2, having registered to receive the universal package delivery service (STEP 1), consumers 14 may shop online on the Website of any online merchant 16. Online merchants 16 may also be registered with the system 10, to participate in universal package delivery, and can query unregistered consumers to register, but the ultimate universal package delivery decision depends on the wishes of the consumer 14.

The system 10, e.g., the central service computer system 12, is adapted to identify the postal zip code associated with the consumer's shipping address once a first-time consumer 14 has indicated that she wants to check out and buy any goods in her shopping cart. Some postal zip codes may not be covered by the system 10 (e.g., due to their remoteness, or, possibly foreign addresses). As a result, consumers with uncovered postal zip codes will not be able to use the universal package delivery system described herein. Repeat consumers 14, who have already been screened and have purchased goods online that could not be shipped to their postal zip code location because it was not covered by a universal shipping address at a local system depot 25, would not have to go through this screening process again.

If, on the other hand, the consumer's postal zip code is covered by the system 10, the system 10, e.g., the central service computer system 12, may automatically populate the shipping information portion of the online merchant's check-out protocol with the universal shipping address at a local system depot 25 (STEP 3) rather than with the consumer's normal shipping address. This population step (STEP 3) may occur whether or not the online merchant 16 has registered with the system 10 as long the consumer 14 has registered with and prefers delivery via the system 10. Optionally, if the consumer's postal zip code is covered by the system 10, the system 10 may automatically generate an interactive window or button for display on the consumer's user interface 11, requiring the consumer 14 to click-on the button, to replace the consumer's normal shipping information with the local address of a system depot 25 (STEP 3). This optional feature may be used once an unregistered consumer 14 has expressed a desire to purchase goods from a registered online merchant 16. The consumer 14 may also manually input or drag-and-drop the universal shipping address at a system depot 25 into the shipping information portion of the online merchant's check-out protocol. The cost for universal package delivery may be paid for by the consumer 14 in a single invoice from the online merchant 16 that is included with the purchase of the goods or in a separate invoice that only covers the shipping, which would come from the party operating the system 10.

The central service computer system 12 may acquire, e.g., by pre-registration or at the time of purchase, the preferred and alternate shipping addresses and other contact information for the consumer 14. This information can be provided to the system depot 25, e.g., via the central service computer system 12, to provide a record of the final destination/delivery address of the package or other deliverable item. The backend also may substitute a shipping code associated with a discrete or particular system depot 25 for the consumer's shipping address (STEP 3).

By substituting the universal shipping address for the consumer's conventional shipping address, the system 10 ensures that an agnostic, first shipping carrier 20 will deliver the package or other deliverable to the system depot 25 at the universal shipping address regardless of the nature of the commercial or governmental carrier. Advantageously, because the local system depot address corresponds to a universal shipping address, the latter can be used by a multiplicity of consumers 14 who are located proximate to the local system depot 25 and who can be serviced by a plurality of shipping carriers 20 and 22. As a result, the system 10 is agnostic as to the particular shipping carrier 20, 22 selected by the consumer 14 or designated by the online merchant 16.

Once the goods are ready for shipment, a first shipping carrier 20 transports the goods to the local system depot 25 (STEP 4) associated with the universal shipping address. As previously mentioned, the first shipping carrier 20 may be randomly selected, selected by the online merchant 16 or selected by the consumer 14. Advantageously, the local system depot 25 is open to receive delivery from the first shipping carrier 20 during normal and extended business hours and, more particularly, is authorized to sign for the goods on the consumer's behalf.

Once the package or deliverable item is received at the local system depot 25 (STEP 4), the system 10 alerts the consumer 14 (STEP 5) as to the availability of the package or deliverable item for delivery and arranging a convenient delivery date and time (STEP 6). In some implementations, communication between the consumer 14 and the local system depot 25 may be transmitted through the Website of the online merchant 16, which can include a dashboard app to enable consumers 14 to track shipping using the merchant's Website instead of the system's Website.

Communication with consumers 14 can be by telephone, text message, email, SMS, MMS, e.g., using the mobile app. Advantageously, communications can include a menu of proposed delivery dates and times (STEP 6) from which the consumer 14 may choose a preferred date and time as well as any alternative dates and times. Preferably, delivery options made available to consumers 14 can include temporally shorter delivery windows, e.g., a one-hour delivery window, rather than the four-hour window offered by some shipping carriers, as well as after hours, e.g., delivery between 6 p.m. and 12 a.m., and/or weekend delivery options.

In some embodiments, delivery locations and times may have different terms, such that locations convenient to transportation hubs or business centers may have lower fees than those in remote, rural areas. Likewise, selection of delivery times may cause the system to increase or decrease fees charged to the consumer or Website. For example, if the consumer can only collect the item during a very short window on a Sunday, a premium charge may be added, whereas collection during an eight-hour window during regular business hours may allow for a discount.

Once the consumer 14 communicates an acceptable, desired delivery date and time to the system 10 (STEP 6), a local carrier 22 may be engaged to deliver the package or deliverable item (STEP 7) from the local system depot 25 to a final destination 29, e.g., the consumer's home address, place of business or requested shipping address, and the local carrier 22 may deliver the package or deliverable item (STEP 7) on the date and at the time requested by the consumer 14.

Advantageously, the system 10 may provide optional alerts to the consumer 14, e.g., by telephone, text message, email, SMS, MMS (e.g., using the mobile app), as desired. Alerts may include the date and time the local carrier 22 picked up the package or deliverable item from the local system depot 25, when the local carrier 22 is within a pre-determined time- or mileage-based radius of the final destination 29, and, more importantly, when applicable, that the local carrier 22 has been or is being delayed.

Returning unwanted or non-conforming goods to online merchants 16 via the system 10 is essentially a mirror image of the universal delivery process. For example, consumers 14 may notify the online merchant 16, e.g., via the central service computer system 12, of the return. when delivered, the package or other deliverable item may include a pre-printed return label that includes the universal shipping address and other contact information of the local depot 25. Once the central service computer system 12 has been alerted, the corresponding local depot 25 will begin to communicate with the consumer 14, trying to arrange a convenient return pick-up date and time. In some implementations, communication between the consumer 14 and the local system depot 25 may be transmitted through the Website of the online merchant 16.

Communication can be by telephone, text message, email, SMS, MMS, e.g., using the mobile app. Advantageously, communications can include a menu of proposed pick-up dates and times from which the consumer 14 may choose a preferred date and time. Preferably, delivery options made available to consumers 14 can include temporally shorter pick-up windows, and provide for after hours and/or weekend pick-up.

Once the consumer 14 communicates a suitable pick-up date and time to the system 10 (STEP 6), the system 10 engages a local carrier 22 to pick-up the package or other deliverable item being returned from consumer's home address, place of business or requested shipping address and to deliver the package or other deliverable item being returned to the local system depot 25, from whence the goods can be returned to the online merchant 16.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. The features and functions of the various embodiments may be arranged in various combinations and permutations, and all are considered to be within the scope of the disclosed invention. Accordingly, the described embodiments are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

What is claimed is:

1. A method for synchronizing delivery time and place of a deliverable item to at least one consumer, the method comprising:
upon receipt of the deliverable item at a pre-designated shipping address, establishing communication via a communication network with a communication device of a discrete consumer who purchased the deliverable item from an online merchant; and
arranging a delivery date and time for transporting the deliverable item from the pre-designated shipping address to a desired final shipping address over the communication device of the discrete consumer.

2. The method of claim 1 further comprising preregistering at least one consumer for universal delivery of the deliverable item.

3. The method of claim 2 further comprising verifying that the at least one consumer has pre-registered for universal delivery of the deliverable item.

4. The method of claim 1 further comprising receiving at the pre-designated shipping address the deliverable item from a first carrier.

5. The method of claim 1 further comprising coordinating delivery of the deliverable item with a second carrier.

6. The method of claim 1 further comprising:
identifying the discrete consumer;
verifying that the discrete consumer has registered for delivery of online purchases to the pre-designated sipping address; and
dynamically replacing a shipping address associated with the discrete consumer with the pre-designated shipping address.

7. The method of claim 6 further comprising verifying that the pre-designated shipping address geographically covers the shipping address of the discrete consumer.

8. The method of claim 1 further comprising providing alerts to the discrete consumer, alerts being provided to at least one of:
notify the discrete consumer once the second carrier has picked up the deliverable item at the pre-designated shipping address;
notify the discrete consumer once the second carrier is within a pre-determined distance to the desired final shipping address;
notify the discrete consumer once the second carrier is within a pre-determined time to the desired final shipping address; and
notify the discrete consumer if the second carrier is delayed.

9. The method of claim 1 further comprising:
upon receipt of a return request, establishing communication via a communication network with the communication device of the discrete consumer who received the deliverable item from; and
arranging a pick-up date and time for transporting the deliverable item from the final shipping address to the pre-designated shipping address over the communication device of the discrete consumer.

10. The method of claim 9 further comprising receiving from a third carrier at the pre-designated shipping address the returned item.

11. The method of claim 10 further comprising coordinating return of the returned item to the online merchant via a fourth carrier.

12. A package delivery system for synchronizing delivery time and place to a plurality of consumers via a communication network, each of the plurality of consumers having a communication device with a processing system, the system comprising:
a non-transitory, machine-readable medium for storing information; and
at least one data processor that is adapted to execute instructions stored in the non-transitory, machine-readable medium and that is configured to:
upon receipt of the at least one item at a pre-designated shipping address, establish communication via the communication network with the communication device of a discrete consumer who has purchased at least one item from an online merchant; and
arrange a delivery date and time for transporting the at least one item from the pre-designated shipping address to a desired final shipping address over the communication device of the discrete consumer.

13. The system of claim 12, wherein the at least one data processor that is further configured to provide the discrete consumer with geographical positioning information when transporting the at least one item from the pre-designated shipping address to a desired final shipping address.

14. The system of claim 12, wherein the at least one data processor that is further configured to verify that the at least one consumer has pre-registered for universal delivery of the deliverable item.

15. The system of claim 12, wherein the at least one data processor that is further configured to:
identify the discrete consumer;
verify that the discrete consumer has registered for delivery of online purchases to the pre-designated sipping address; and
dynamically replace a shipping address associated with the discrete consumer with the pre-designated shipping address.

16. The method of claim 16, wherein the at least one data processor is further configured to verify that the pre-designated shipping address geographically covers the shipping address of the discrete consumer.

17. The system of claim 12, wherein the at least one data processor that is further configured to:
upon receipt of a return request, establish communication via a communication network with the communication device of the discrete consumer who received the deliverable item from; and
arrange a pick-up date and time for transporting the deliverable item from the final shipping address to the pre-designated shipping address over the communication device of the discrete consumer.
